(19) United States
(12) Patent Application Publication
(10) Pub. No.: US 2013/0151838 A1
(43) Pub. Date: Jun. 13, 2013

(54) CIRCUIT FOR REMOVING PASSWORDS

(71) Applicants: CHUN-SHENG CHEN, Tu-Cheng (TW); HUA ZOU, Shenzhen City (CN)

(72) Inventors: CHUN-SHENG CHEN, Tu-Cheng (TW); HUA ZOU, Shenzhen City (CN)

(73) Assignees: HON HAI PRESICION INDUSTRY CO., LTD., Tu-Cheng (TW); HONG FU JIN PRECISION INDUSTRY (ShenZhen) CO., LTD, Shenzhen City (CN)

(21) Appl. No.: 13/340,682

(22) Filed: Dec. 30, 2011

(30) Foreign Application Priority Data
Dec. 9, 2011 (CN) 201110408406.X

(51) Int. Cl. G06F 1/24

(52) U.S. Cl. 713/100

(57) ABSTRACT

A circuit for removing passwords from a computer includes a jumper and a power circuit. The jumper includes a base and a jumper block. The base includes first to fourth pins. The first pin is idle. The third pin is grounded. The second pin is coupled to a basis input output system (BIOS) chip of the computer, the fourth pin is coupled to a complementary metal-oxide-semiconductor (CMOS) chip of the computer. The power circuit is coupled to the second and the fourth pins, to supply power for the BIOS chip and the CMOS chip. The jumper block is plugged between the second and the third pins to remove the password in the BIOS chip, and plugged between the third and the fourth pins to remove the password in the CMOS chip.

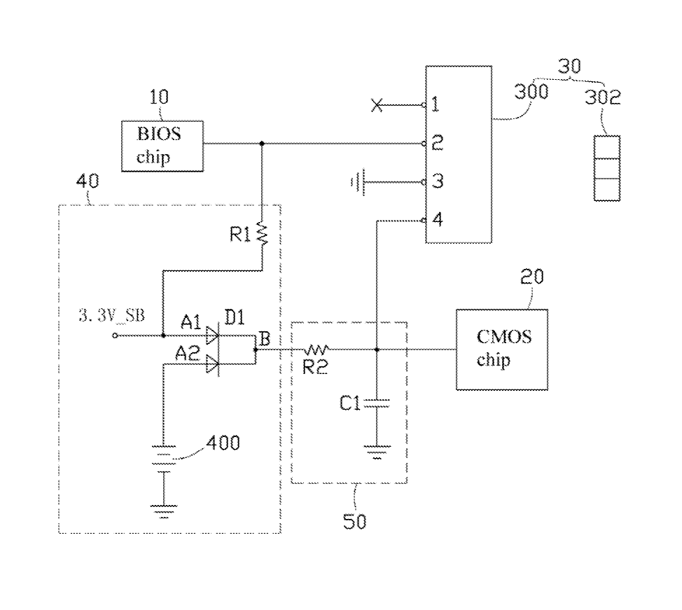

### BACKGROUND

1. Technical Field

The present disclosure relates to a circuit for removing passwords.

2. Description of Related Art

To maintain the recorded hardware details of a computer against change by unauthorized users, the owner of the computer may set passwords in a basic input output system (BIOS) and in a complementary metal-oxide-semiconductor (CMOS) of the computer. If the owner wants to upgrade the BIOS and CMOS later, he may have forgotten the passwords set previously. In that case, two jumpers may be used to remove the passwords in the BIOS and the CMOS. Each jumper includes a base and a jumper block. The base includes first to third pins. The first pin is grounded, the second pin is idle, and the third pin is coupled to one of the BIOS and CMOS. In removing the password in the BIOS or CMOS, the jumper block must be plugged between the second and the third pins. However, a large and inconvenient amount of space is needed to arrange two jumpers on the motherboard. Thus, there is room for improvement in the art.

### BRIEF DESCRIPTION OF THE DRAWING

Many aspects of the present disclosure can be better understood with reference to the drawing. The components in the drawing are not necessarily drawn to scale, the emphasis instead being placed upon clearly illustrating the principles of the present disclosure.

The figure is a circuit diagram of an embodiment of a circuit for removing passwords.

### DETAILED DESCRIPTION

Referring to the figure, one embodiment is presented of a circuit for removing passwords of a basic input output system (BIOS) chip 10 and a complementary metal-oxide-semiconductor (CMOS) chip 20 arranged on a motherboard (not shown) of a computer. The circuit includes a jumper 30, a power circuit 40, and a filtering circuit 50.

The jumper 30 includes a base 300 and a jumper block 302. The base 300 includes first to fourth pins 1-4 equidistantly arranged in a row. The first pin 1 is idle, the third pin 3 is grounded, the second pin 2 is coupled to the BIOS chip 10, and the fourth pin 4 is coupled to the CMOS chip 20.

The power circuit 40 includes a 3.3 volt power source (3.3V_SB), a battery 400, a Schottky diode D1, and a resistor R1. The power source 3.3V_SB is coupled to a first anode Al of the Schottky diode D1, and is also coupled to the second pin 2 through the resistor R1. The cathode of the battery 400 is grounded. The anode of the battery 400 is coupled to a second anode A2 of the Schottky diode D1.

The filtering circuit 50 includes a resistor R2 and a capacitor C1. A first terminal of the resistor R2 is coupled to a cathode B of the Schottky diode D1. A second terminal of the resistor R2 is coupled to the fourth pin 4 and the CMOS chip 20, and is also grounded through the capacitor C1. The battery 400 supplies power for the maintenance of the passwords in the BIOS chip 10 and the CMOS chip 20 through the Schottky diode D1. For as long as an external power source is applied to the computer, the power source 3.3V_SB supplies power for the maintenance of the passwords in the BIOS chip 10 and the CMOS chip 20 through the Schottky diode D1.

In order to keep the passwords in the BIOS chip 10 and the CMOS chip 20, the jumper block 302 is by default plugged between the first pin 1 and the second pin 2.

In order to remove the password in the BIOS chip 10, the jumper block 302 must be plugged between the second pin 2 and the third pin 3. When the voltage of the second pin 2 is at a low level, such as logic 0, the password in the BIOS chip 10 is removed automatically. To remove the password in the CMOS chip 20, the jumper block 302 must be plugged between the third pin 3 and the fourth pin 4. When the voltage of the fourth pin 4 is at a low level, the password in the CMOS chip 20 is removed automatically.

The circuit can remove the passwords in both the BIOS chip 10 and the CMOS chip 20 by plugging the jumper block 302 between different pins of the base 300. That is to say, only one jumper 30 is necessary to remove the passwords in the BIOS chip 10 and the CMOS chip 20, which is an inexpensive and very convenient option.

While the disclosure has been described by way of example and in terms of a preferred embodiment, it is to be understood that the disclosure is not limited thereto. On the contrary, it is intended to cover such modifications and similar arrangements as would be apparent to those skilled in the art. Therefore, the scope of the appended claims should be accorded the broadest interpretation so as to encompass all such modifications and similar arrangements.

What is claimed is:

1. A circuit for removing passwords in a basic input output system (BIOS) chip and a complementary metal-oxide-semiconductor (CMOS) chip, comprising:
a jumper comprising a base and a jumper block, the base comprising first to third pins, wherein the second pin is connected to ground, the first pin is coupled to the BIOS chip, the third pin is coupled to the CMOS chip; and
a power circuit coupled to the first and the third pins, to supply power for the BIOS chip and the CMOS chip;
wherein the jumper block is operable to be plugged between the first and the second pins to remove the password in the BIOS chip, and the jumper block is operable to be plugged between the second and the third pins to remove the password in the CMOS chip.

2. The circuit of claim 1, further comprising a filtering circuit, wherein the filtering circuit comprises a resistor and a capacitor, wherein a first end of the resistor is coupled to the power circuit, and a second end of the resistor is connected to ground through the capacitor, and coupled to the CMOS chip and the third pin of the base.

3. The circuit of claim 1, wherein the power circuit comprises a battery, a power source, a Schottky diode, the power source is coupled to a first anode of the Schottky diode and the first pin; a cathode of the battery is connected to ground, an anode of the battery is coupled to a second anode of the Schottky diode; a cathode of the Schottky diode is coupled to the third pin of the base.

4. The circuit of claim 3, wherein the power circuit further comprises a resistor, the first anode of the Schottky diode is coupled to the first pin of the base through the resistor.

5. The circuit of claim 1, wherein the first, the second, and the third pins are arranged in sequence.

6. The circuit of claim 5, wherein the first to third pins are equidistantly arranged.

7. The circuit of claim 1, wherein the base further comprises a fourth pin which is idle, the jumper block is operable to be plugged between the first pin and the fourth pin to maintain the passwords in the BIOS chip and the CMOS chip.

8. The circuit of claim 7, wherein the fourth pin and the first to third pins are arranged in sequence.

9. The circuit of claim 8, wherein the fourth pin and the first to third pins are equidistantly arranged.
